(19) United States
(12) Patent Application Publication
(10) Pub. No.: US 2019/0251605 A1
(43) Pub. Date: Aug. 15, 2019

(54) SMART FUNDRAISING SYSTEM USING KIOSK

(71) Applicants: Myeong Sang YU, Yeongwol-gun (KR); Da En YU, Seoul (KR); Seng Min YU, Seoul (KR); II Sang YOO, Sejong (KR)

(72) Inventors: Myeong Sang YU, Yeongwol-gun (KR); Da En YU, Seoul (KR); Seng Min YU, Seoul (KR); II Sang YOO, Sejong (KR)

(21) Appl. No.: 16/317,242

(22) PCT Filed: Jul. 17, 2017
(86) PCT No.: PCT/KR2017/007645

§ 371 Date: Jan. 11, 2019

(30) Foreign Application Priority Data
Jul. 15, 2016 (KR) 10-2016-0090231

(51) Int. Cl. G06Q 30/02; G06Q 20/18; G06Q 20/04

(52) U.S. Cl. CPC G06Q 30/0279; G06Q 30/0237; G06Q 30/0268; G06Q 20/18; G06Q 20/045; G06Q 30/0212

(57) ABSTRACT

An embodiment of the present invention comprises: a smart donation-fundraising server for saving information on in-kind donation, which refers to goods donated by a corporation, as in-kind donation information, generating and saving in-kind donation advertisement content which refers to advertisement content for the in-kind donation, and reporting as the amount corresponding to the in-kind donation as cash donation by the corporation that has provided the in-kind donation; a kiosk for receiving, from the smart donation-fundraising server, the in-kind donation advertisement content and displaying same, and printing and providing an exchange coupon allowing free exchange of the in-kind donation or a discount coupon allowing purchase of the in-kind donation at a discounted price, when a cash donation payment has been made to purchase the in-kind donation; and a cable/wireless communication network for providing cable communication or wireless communication between the smart donation-fundraising server and the kiosk.

### TECHNICAL FIELD

The present invention relates to a smart fundraising system, and particularly, to a system for fundraising using a kiosk.

### BACKGROUND ART

Generally, religious groups, the Red Cross, the Community Chests, the UNICEF, or other fundraising organizations collect donations to operate the organizations and give financial support for their staff and their family as well as for various events they hold, non-selfstanding local governments or devastated people.

Typically, donation may be carried out in various manners, such as by hand delivery, telephone, or money transfer online.

However, hand delivery donation requires it to be done only by cash, and online transfer needs the donor's bank account to be in the enough balance for the donation. Telephone donation is limited in amount.

Furthermore, hand delivery donation may pose too much labor and time on the donee organization to handle donations.

When made by hand delivery, each donation should be handled by the staff of the organization, which is time-consuming and inefficient.

Telephone donation may not be tax-deductible.

Nowadays, the concept of corporate social responsibility (CSR) becomes more critical in running business, which means that companies seek the interests of the entire community beyond their own interests in their business activity and any decisions or activities should be aligned therewith. By CSR, companies attempt to increase their sustaining value while continuing to create achievements in environmental or social aspects. Such CSR would work as a major factor in business competitivity.

Thus, a need exists for a brand-new type of donation means to allows any individual or company to attend donation activities beyond mere money donation.

### SUMMARY

### Objects

The present invention aims to provide a smart fundraising system using a kiosk which is a brand-new type of donation to allow any individual or business to attend donation.

### Configuration

According to an embodiment of the present invention, there is provided a smart fundraising system using a kiosk, the smart fundraising system comprising a smart fundraising server storing information about an in-kind donation received from a business as in-kind donation information, generating and storing an in-kind donation advertisement content which is an advertisement content about the in-kind donation, and processing a reporting of an amount of money corresponding to the in-kind donation as a donation of the business, a kiosk receiving the in-kind donation advertisement content from the smart fundraising server and displaying the in-kind donation advertisement content and, where donation money for purchasing the in-kind donation is paid, providing an exchange coupon for exchanging with the in-kind donation or outputting and providing a discount coupon for purchasing the in-kind donation at a discount, and a wired/wireless communication network providing wired or wireless communication between the smart fundraising server and the kiosk.

The exchange coupon or the discount coupon may be provided in the form of a mobile coupon to a mobile terminal of an in-kind donation buyer who pays a donation amount to buy the in-kind donation.

The kiosk may include an in-kind donation advertisement content storage unit storing the in-kind donation advertisement content received from the smart fundraising server, a printing unit printing the exchange coupon or the discount coupon, a cash counter counting and grasping the amount of cash inserted and storing the inserted cash in a cash container, a card payment unit reading card information to make payment by card, an input unit receiving information about a donee organization and information about the in-kind donation buyer, a display unit displaying the in-kind donation advertisement content and the amount of cash counted by the cash counter or card payments made by the card payment unit, and a controller outputting and providing the exchange coupon or the discount coupon where the amount of cash or the card payments exceed a preset minimum donation amount and transmitting the information about the donee organization and the information about the in-kind donation buyer to the smart fundraising server.

The controller may provide the exchange coupon to a winning in-kind donation buyer and the discount coupon to a non-winning in-kind donation buyer by a preset winning algorithm.

The winning algorithm may be configured to increase a probability of winning the exchange coupon as the donation amount increases.

The in-kind donation information may include a kind, an image, and a place of purchase of the in-kind donation, the number of exchange coupons, the number of discount coupons, and a discount rate of the discount coupons, and the printing unit may receive the in-kind donation information from the smart fundraising server and prints the image of the in-kind donation, information about the place of purchase of the in-kind donation, and the discount rate of the discount coupons on the exchange coupon and discount coupon based on the in-kind donation information.

A coupon count ratio which is a ratio of the number of the exchange coupons to the number of the discount coupons may be determined depending on the kind of the in-kind donation.

The coupon count ratio may be determined such that as a price of the in-kind donation increases, the number of the discount coupons is larger than the number of the exchange coupons.

The discount rate of discount coupon may be determined to increase as the donation amount for purchasing an in-kind donation increases.

### Effects of the Invention

According to the embodiments of the present invention may foster the culture of donation by in-kind donation. For an in-kind donation, a coupon may be provided, leading to secondary donation.

### BRIEF DESCRIPTION OF DRAWINGS

FIG. 1 is a view illustrating a configuration of a smart fundraising system using a kiosk according to an embodiment of the present invention;

FIG. 2 is a view illustrating a configuration of a smart fundraising system using a kiosk in which a mobile coupon is delivered to a donor according to an embodiment of the present invention;

FIG. 3 is a perspective view illustrating a kiosk according to an embodiment of the present invention;

FIG. 4 is a block diagram illustrating a configuration of a kiosk according to an embodiment of the present invention;

FIG. 5 is a view illustrating an example of an exchange coupon according to an embodiment of the present invention;

FIG. 6 is a view illustrating a discount coupon according to an embodiment of the present invention;

FIG. 7 is a view illustrating an example of a coupon count ratio according to an embodiment of the present invention; and

FIG. 8 is a view illustrating an example of determining a higher discount rate for a larger donation.

### MODE FOR CARRYING OUT THE INVENTION

Advantages and features of the present invention, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present invention. The present invention is defined only by the appended claims. When determined to make the subject matter of the present invention unclear, the detailed description of the known art or functions may be omitted.

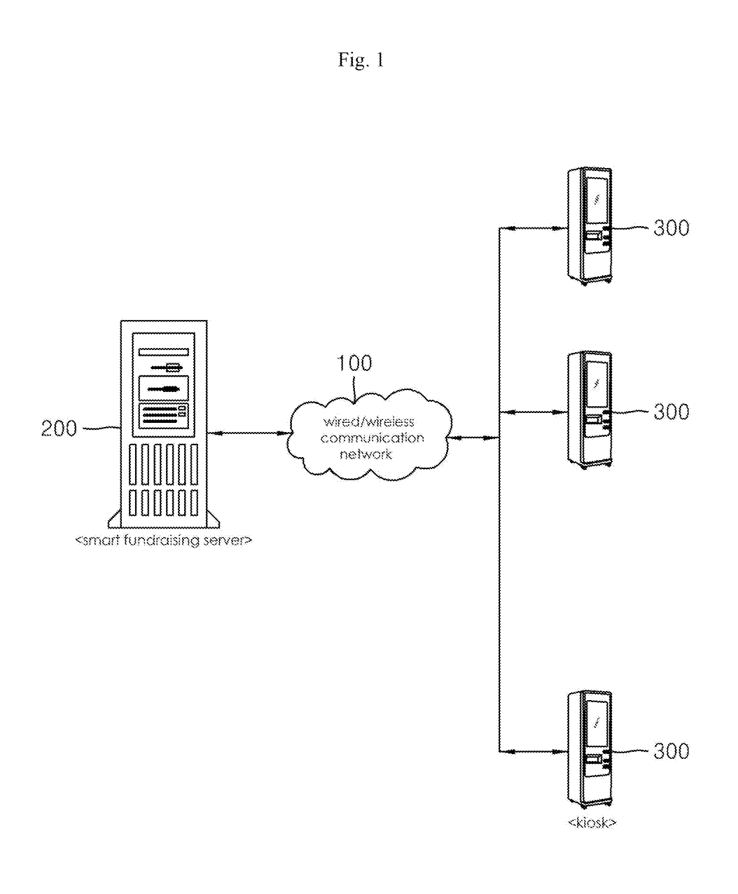

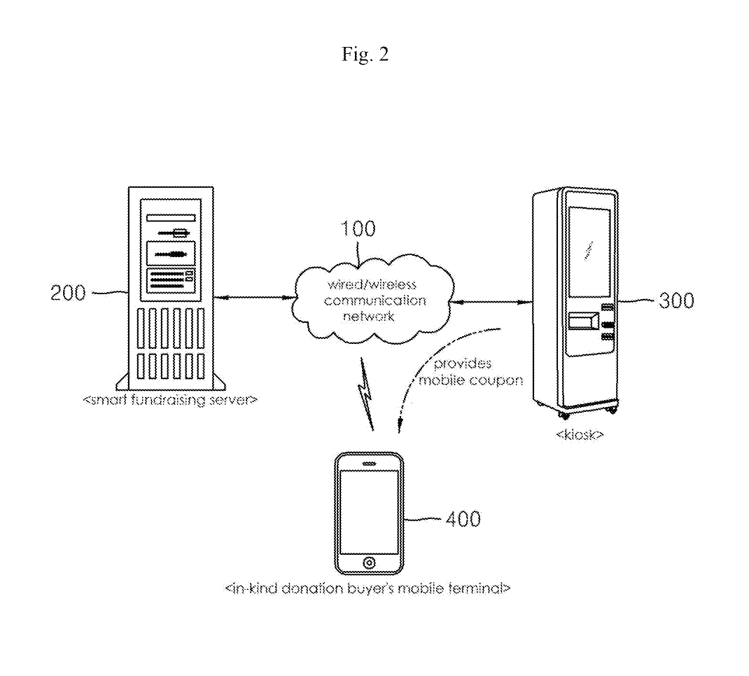

FIG. 1 is a view illustrating a configuration of a smart fundraising system using a kiosk according to an embodiment of the present invention. FIG. 2 is a view illustrating a configuration of a smart fundraising system using a kiosk in which a mobile coupon is delivered to a donor according to an embodiment of the present invention.

The present invention prompts donation by receiving in-kind, but rather than money, donations.

The present invention secures a supply by primarily receiving in-kind donations from an online marketplace (or online shopping mall), outputs advertisements or advertisement content about the in-kind donations through kiosks 300 installed in public place, secondarily receives donations for entry capital for receiving exchange coupons for the in-kind donations, issues an exchange coupon only to a winning entry while issuing discount coupons (one item commerce) for the in-kind donations to the other non-winning entries to compensate them for the entry capital.

For example, if a fast-food restaurant donates hamburgers, and the donations are delivered to customers by the machine, the customers visit the restaurant. The Red Cross issues the receipts for the donations, and the delivery is made via a mobile coupon and authentication system to the customers. To promote donation or foster a culture of donation, 100 Korean won (KRW) per hamburger is received as a donation. By so doing, businesses may take advantage of donation not only for tax return purposes but also for donation, advertisement, and revenue-boosting purposes. According to the present invention, the smart fundraising system using the kiosks 300 enables in-kind donation of, e.g., pizza, chicken, coffee, stationery, clothing, or electronics, a filing of a tax return and advertisement, and allows customers to revisit the store, increasing revenue.

To that end, according to the present invention, the smart fundraising system using the kiosks 300 may include a wired/wireless communication network 100, a smart fundraising server 200 and kiosks 300.

The wired/wireless communication network 100 is a communication network to provide wired or wireless communication between the smart fundraising server 200 and the kiosks 300. Where the wired/wireless communication network 100 is implemented as a wireless communication network, data communication may be performed via a wireless mobile communication network including a base station (or base transceiver station (BTS)), a mobile switching center (MSC), and a home location register (HLR). Where the wired/wireless communication network 100 is implemented as a wired communication network, data communication may be performed as per internet protocols, such as transmission control protocol/internet protocol (TCP/IP).

The smart fundraising server 200 stores information about an in-kind donation received from a business as in-kind donation information. The in-kind donation information may include the kind, image, and place of purchase of the in-kind donation, the number of exchange coupons, the number of discount coupons, and the discount rate of the discount coupons. For example, where 1,000 hamburgers are given as an in-kind donation by company A, the image of the in-kind donation may be a hamburger-looking image, and the place of purchase of the in-kind donation may correspond to the locations of branch stores of company A. The number of discount coupons for exchanging with hamburgers may be determined to be 100, and the number of 10% discount coupons may be determined to be 900.

The smart fundraising server 200 may create and store in-kind donation advertisement content which is advertisement content for the in-kind donation, provide the in-kind donation advertisement content to each of the plurality of kiosks 300, and reports the amount corresponding to the in-kind donation, as the donation of the company which has given the in-kind donation, to the National Tax Service server. Thus, the company which has given the in-kind donation may get a tax deduction, saving its taxes.

For reference, the smart fundraising server 200 may have substantially the same configuration as a typical web server in terms of hardware to implement the above-described operations and may be implemented in various programming languages, such as C, C++, Java, Visual Basic, or Visual C in terms of software while including programming modules that have various functions. The real property agency server 300 may also be implemented by combining various web server programs which are provided depending on operating systems (OSs), such as Dos, Window, Linus, Unix, or Macintosh, with a common hardware device for servers.

The kiosk 300 is an unmanned information providing device installed in such public place as, e.g., a local government office, bank, department store, or exhibition to receive donations. The kiosk 300 may use a touchscreen, sounds, graphics, communication card, or other state-of-art multimedia devices to provide users with coupons for in-kind donations given by businesses and secondarily collect predetermined donations in return.

To that end, the kiosk 300 receives the in-kind donation advertisement content from the smart fundraising server 200 and displays the in-kind donation advertisement content. Where an amount of donation money (donation amount) is paid to purchase an in-kind donation, the kiosk 300 may provide an exchange coupon for free exchange of the in-kind donation or output and provide a discount coupon for purchasing the in-kind donation at a discount.

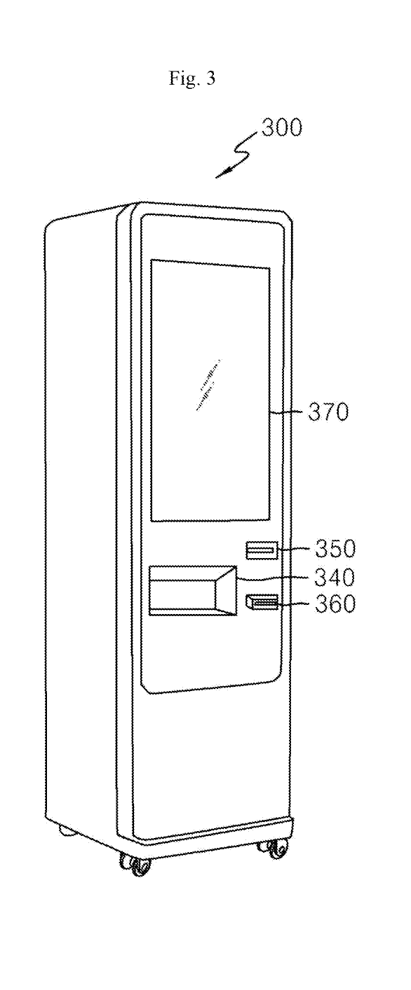

For example, where company A donates 1,000 hamburgers as an in-kind donation, and a donation amount of 100 KRW is paid to purchase a hamburger donated by cash or card on the kiosk 300, the kiosk 300 may provide the person who donated by purchasing the in-kind donation with an exchange coupon by which he may get a free hamburger from company A or to provide a 10% discount coupon for a hamburger from company A. The exchange coupon or discount coupon may be printed on paper or, as shown in FIG. 2, be provided in the form of a mobile coupon on the mobile terminal 400 of the purchaser. The kiosk 300 is described below in connection with FIGS. 3 to 8.

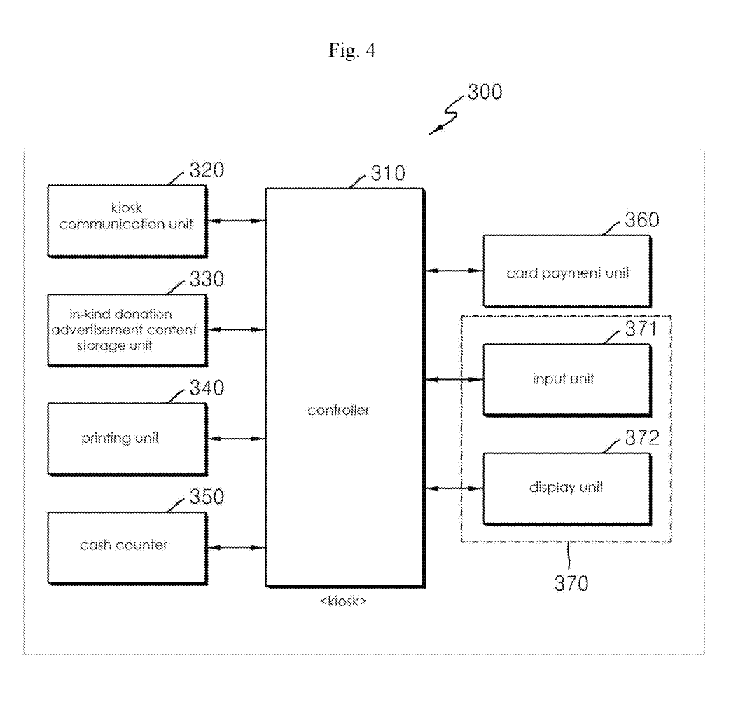

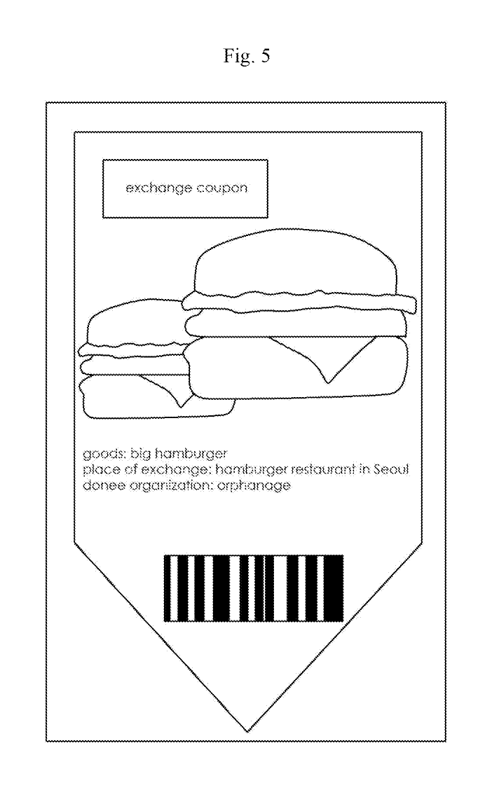

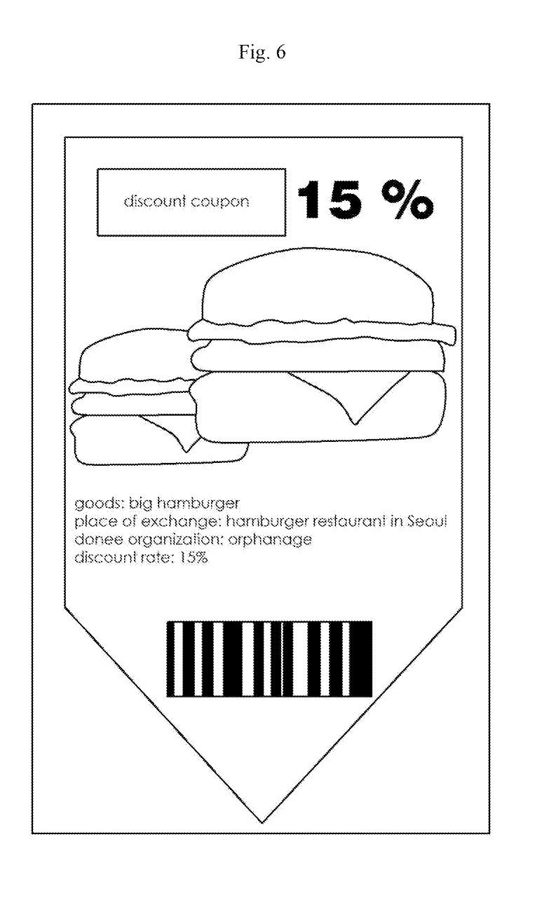

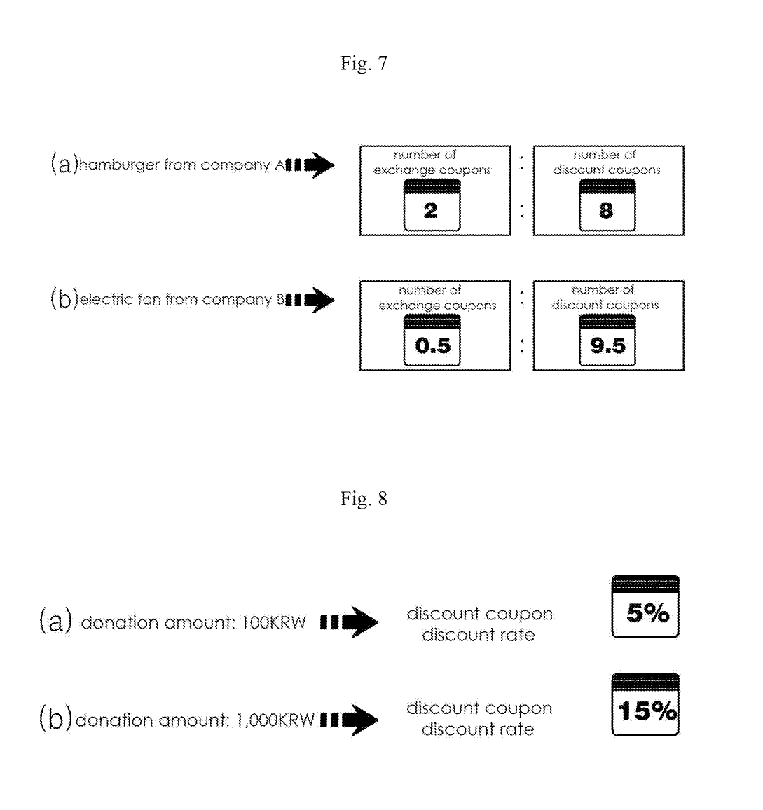

FIG. 3 is a perspective view illustrating a kiosk according to an embodiment of the present invention. FIG. 4 is a block diagram illustrating a configuration of a kiosk according to an embodiment of the present invention. FIG. 5 is a view illustrating an example of an exchange coupon according to an embodiment of the present invention. FIG. 6 is a view illustrating a discount coupon according to an embodiment of the present invention. FIG. 7 is a view illustrating an example of a coupon count ratio according to an embodiment of the present invention. FIG. 8 is a view illustrating an example of determining a higher discount rate for a larger donation.

As shown in FIGS. 3 and 4, the kiosk 300 may include a kiosk communication unit 320, an in-kind donation advertisement content storage unit 330, a printing unit 340, a cash counter 350, a card payment unit 360, a touchscreen panel 370 including an input unit 371 and a display unit 372, and a controller 310.

The kiosk communication unit 320 supports protocols of hardware and software to communicate with the smart fundraising server 200. The kiosk communication unit 320 may perform data communication as per Internet protocols, such as transmission control protocol/Internet protocol (TCP/IP).

The in-kind donation advertisement content storage unit 330 is a database (DB) storing in-kind donation advertisement content received from the smart fundraising server 200. It is apparent that the in-kind donation advertisement content may be in the form of, e.g., photos, images, animations, videos, text, or other various content. The in-kind donation advertisement content storage unit 300 may be provided inside the device, as a module capable of inputting or outputting information, such as a hard disk drive (HDD), a solid state drive (SSD), a flash memory, a compact flash (CF) card, a secure digital (SD) card, a smart media (SM) card, a multi-media card (MMC), or a memory stick', or the database may be provided in a separate device.

The printing unit 340 prints out exchange coupons for getting in-kind donations free or discount coupons for purchasing in-kind donations at a discount. The exchange coupons and discount coupons may be printed on paper or may be printed and generated in the form of image files.

The in-kind donation information may include the kind, image, and place of purchase of the in-kind donation, the number of exchange coupons, the number of discount coupons, and the discount rate of the discount coupons. The printing unit 340 may receive the in-kind donation information from the smart fundraising server 200 and print the image of the in-kind donation, information about the place of purchase of the in-kind donation, and the discount rate of the discount coupon on the exchange coupon and discount coupon based on the in-kind donation information. FIG. 5 illustrates an example of an exchange coupon. An image, name, place of exchange, barcode or QR code, and donee organization for an in-kind donation exchangeable may be printed on the exchange coupon. FIG. 6 illustrates an example of a discount coupon. An image, name, sale price, place of purchase, discount rate, barcode or QR code, and donee organization for an in-kind donation may be printed on the discount coupon.

The cash counter 350 counts and grasps cash put in and stores the cash in a cash container. The cash counter 350 may include a bill counting module capable of counting bills and a coin counting module capable of counting coins.

The card payment unit 360 may read card information for payment by card. The card payment unit 360 may read financial cards, such as check cards, credit cards, or donation-dedicated cards to pay the donation amount entered through a value added network (VAN).

The input unit 371 may receive information about a donee organization and information about an in-kind donation buyer. The in-kind donation buyer refers to a donor who buys the in-kind donation. The information about the in-kind donation buyer may be, e.g., the donor's cell phone number or resident registration number. The information about the in-kind donation buyer may be transmitted to the smart fundraising server 200 to process the receipt for the donation. The information about the donee organization is information about the organization directly chosen by the in-kind donation buyer among orphanages, nursing homes, and missionary groups. The information about the donee organization may be transmitted to the smart fundraising server 200 so that the donation amount used for payment by the in-kind donation buyer may be donated to the organization chosen by the in-kind donation buyer.

The display unit 372 may display in-kind donation advertisement content and the amount of cash counted by the cash counter 350 or the card payments made by the card payment unit 360. The input unit 371 and the display unit 372 may be implemented as a single form of the touchscreen panel 370. The touchscreen panel 370 may display a graphic user interface (GUI) for communication with the in-kind donation buyer as a display window to display task screens as prepared on the front surface of the terminal and to provide a touchscreen screen capable of both entry and display.

The controller 310 may output and provide an exchange coupon or a discount coupon where the amount of cash or the card payments exceed a preset minimum donation amount. The controller 310 transmits the information about the donee organization and the information about the in-kind donation buyer to the smart fundraising server 200.

For example, where the minimum donation amount for exchanging or discounting a hamburger as donated in kind by company A is 100 KRW and is paid, an exchange coupon for exchanging with a hamburger donated in kind by company A or a discount coupon for 10% discounting the hamburger may be output and provided. The controller 310 transmits the information about the donor and the information about the donee organization, along with the indication that the money of 100 KRW has been donated, to the smart fundraising server 200. The smart fundraising server 200 may donate the donation amount paid through the kiosk 300 to the chosen organization and process the receipt for the donation as information about the in-kind donation buyer.

Where the cash amount or the card payments exceeds the preset minimum donation amount, the controller 310 outputs and provides an exchange coupon or a discount coupon. In providing such an exchange coupon or discount coupon, the kind of the coupon is determined by a preset winning algorithm. In other words, the controller 310 provides an exchange coupon to an in-kind donation buyer who is determined lined as a winner by the preset winning algorithm and provides discount coupons to other non-winning in-kind donation buyers. Thus, an in-kind donation buyer who paid a donation amount of 100 KRW to buy an in-kind donation may obtain an exchange coupon which he can exchange with a hamburger worth 4,000 KRW if he is determined as a winner, or although not winning, be given a discount coupon to allow him to buy the hamburger at a 10% discounted price, i.e., 3,600 KRW. Even given the paid donation amount, the in-kind donation buyer may still buy the in-kind donation at lower price, and this may prompt payment for donations using the kiosk 300. This way leads to an easier changing of in-kind donations from businesses into cash and donation of the cash to organizations that require a fund.

Meanwhile, the winning algorithm may be implemented in such a manner that as the donated money increases, the likelihood to win an exchange coupon increases. For example, the winning algorithm may variably be implemented in such a manner that where the minimum donation amount of 100 KRW is paid, the probability of winning an exchange coupon is 1%, where 200 KRW is paid as a donation payment, the probability is 2%, where 300 KRW is paid, the probability is 3%, and where 400 KRW is paid, the probability is 4%. This may encourage donation.

Meanwhile, the coupon count ratio, which is a ratio of the number of exchange coupons to the number of discount coupons, may be determined depending on the kind of in-kind donations. For example,

where the number of coupons for exchanging or discounting in-kind donations is set to 1,000, among the 1,000 coupons, 100 coupons may be exchange coupons, and the remaining 900 coupons may be discount coupons in which case the coupon count ratio of the number of exchange coupons to the number of discount coupons is 100:900, i.e., 1:9.

The coupon count ratio may be varied depending on the kind of the in-kind donations. That is, for the strategical purpose of attracting customers to the store, the coupon count ratio may be determined to differ depending on the kind of in-kind donations.

In particular, the coupon count ratio may be determined such that as the price of the in-kind donation increases, the number of discount coupons increases over the number of exchange coupons.

For example, as shown in FIG. 7(a), for hamburgers from company A, the coupon count ratio of the number of exchange coupons to the number of discount coupons may be 2:8, and as shown in FIG. 7(b), for electric fans from company B, the coupon count ratio of the number of exchange coupons to the number of discount coupons may be 0.5:9.5 This may be done so to attract more customers to the store by issuing more discount coupons for higher in-kind donations.

Meanwhile, the discount rate of discount coupon may be determined to increase as the donation amount for purchasing an in-kind donation increases. For example, as shown in FIG. 8(a), where 100 KRW is paid as a donation amount through the kiosk 300, the discount rate of discount coupon may be 5%, and as shown in FIG. 8(b), where 1,000 KRW is paid as a donation amount through the kiosk 300, the discount rate of discount coupon may be 15%. More donation may be encouraged for a higher discount rate.

While the present invention has been shown and described with reference to exemplary embodiments thereof, it will be apparent to those of ordinary skill in the art that various changes in form and detail may be made thereto without departing from the spirit and scope of the present invention as defined by the following claims.

1. A smart fundraising system using a kiosk, the smart fundraising system comprising:
a smart fundraising server storing information about an in-kind donation received from a business as in-kind donation information, generating and storing an in-kind donation advertisement content which is an advertisement content about the in-kind donation, and processing a reporting of an amount of money corresponding to the in-kind donation as a donation of the business:
a kiosk receiving the in-kind donation advertisement content from the smart fundraising server and displaying the in-kind donation advertisement content and, where a donation amount for purchasing the in-kind donation is paid, providing an exchange coupon for exchanging with the in-kind donation or outputting and providing a discount coupon for purchasing the in-kind donation at a discount; and
a wired/wireless communication network providing wired or wireless communication between the smart fundraising server and the kiosk.

2. The smart fundraising system of claim 1, wherein the exchange coupon or the discount coupon is provided in the form of a mobile coupon to a mobile terminal of an in-kind donation buyer who pays a donation amount to buy the in-kind donation.

3. The smart fundraising system of claim 1, wherein the kiosk includes an in-kind donation advertisement content storage unit storing the in-kind donation advertisement content received from the smart fundraising server, a printing unit printing the exchange coupon or the discount coupon, a cash counter counting and grasping the amount of cash inserted and storing the inserted cash in a cash container, a card payment unit reading card information to make payment by card, an input unit receiving information about a donee organization and information about the in-kind donation buyer, a display unit displaying the in-kind donation advertisement content and the amount of cash counted by the cash counter or card payments made by the card payment unit, and a controller outputting and providing the exchange coupon or the discount coupon where the amount of cash or the card payments exceed a preset minimum donation amount and transmitting the information about the donee organization and the information about the in-kind donation buyer to the smart fundraising server.

4. The smart fundraising system of claim 3, wherein the controller provides the exchange coupon to a winning in-kind donation buyer and the discount coupon to a non-winning in-kind donation buyer by a preset winning algorithm.

5. The smart fundraising system of claim 4, wherein the winning algorithm is configured to increase a probability of winning the exchange coupon as the donation amount increases.

6. The smart fundraising system of claim 4, wherein the in-kind donation information may include a kind, an image, and a place of purchase of the in-kind donation, the number of exchange coupons, the number of discount coupons, and a discount rate of the discount coupons, and wherein the printing unit receives the in-kind donation information from the smart fundraising server and prints the image of the in-kind donation, information about the place of purchase of the in-kind donation, and the discount rate of the discount coupons on the exchange coupon and discount coupon based on the in-kind donation information.

7. The smart fundraising system of claim 6, wherein a coupon count ratio which is a ratio of the number of the exchange coupons to the number of the discount coupons is determined depending on the kind of the in-kind donation.

8. The smart fundraising system of claim 7, wherein the coupon count ratio is determined such that as a price of the in-kind donation increases, the number of the discount coupons is larger than the number of the exchange coupons.

9. The smart fundraising system of claim 6, wherein the discount rate of the discount coupons is determined to be higher as the donation amount for purchasing the in-kind donation increases.
